(19) United States
(12) Patent Application Publication
(10) Pub. No.: US 2022/0175113 A1
(43) Pub. Date: Jun. 9, 2022

(54) HAIRSTYLE MAKING PROCEDURE PROPOSAL APPARATUS, HAIRSTYLE MAKING PROCEDURE PROPOSAL METHOD, AND NON-TRANSITORY COMPUTER READABLE MEDIUM

(71) Applicant: NEC Corporation, Tokyo (JP)

(72) Inventors: Takashi MARUYAMA, Tokyo (JP); Kozo Satoda, Tokyo (JP); Takayuki Kuroda, Tokyo (JP); Yutaka Yakuwa, Tokyo (JP); Takuya Kuwahara, Tokyo (JP); Tatsuya Fukuda, Tokyo (JP); Kazuki Tanabe, Tokyo (JP)

(73) Assignee: NEC Corporation, Tokyo (JP)

(21) Appl. No.: 17/542,697

(22) Filed: Dec. 6, 2021

(30) Foreign Application Priority Data
Dec. 9, 2020 (JP) 2020-203908

(51) Int. Cl. A45D 44/00; G06Q 30/06; G06V 40/16; G06V 20/20

(52) U.S. Cl. CPC A45D 44/005; G06Q 30/0621; A45D 2044/007; G06V 40/161; G06V 20/20; G06Q 30/0643

(57) ABSTRACT

An apparatus includes an input unit that receives an input of a requirement and a condition for a hairstyle, a correspondence relationship storage unit that stores a first correspondence relationship between an element characterizing the hairstyle and the hairstyle, a hairstyle model storage unit that stores a hairstyle model, a procedure storage unit that stores a hairstyle making procedure, a search unit that selects the type of hairstyle based on the element included in the input requirement and the first correspondence relationship, determines a value of the variable included in the hairstyle model of the selected type of hairstyle based on the input condition, and assigns the determined value to the variable included in the hairstyle making procedure of the selected type of hairstyle, and an output unit that outputs the selected type of hairstyle and output the hairstyle making procedure after the value is assigned to the variable.

### INCORPORATION BY REFERENCE

This application is based upon and claims the benefit of priority from Japanese patent application No. 2020-203908, filed on Dec. 9, 2020, the disclosure of which is incorporated herein in its entirety by reference.

### TECHNICAL FIELD

The present disclosure relates to a hairstyle making procedure proposal apparatus, a hairstyle making procedure proposal method, and a non-transitory computer readable medium.

### BACKGROUND ART

In related art, when a hairstylist works on hair of a customer, the hairstylist works on the hair of the customer after the customer presents a hairstyle similar to the hairstyle he/she wants or the hairstylist asks the customer what his/her favorite hairstyle is.

Therefore, a hairstylist needs a great deal of knowledge in order to work on hair of a customer in such a way as to correspond with the customer's request.

Therefore, recently, in order to supplement the hairstylists' knowledge, there has been a demand for a technique by which types of hairstyles and hairstyle making procedures which correspond to requests from customers can be proposed.

For example, according to the technique disclosed in Japanese Unexamined Patent Application Publication No. 2017-016418, a hairstylist consults with a customer about the hairstyle he/she wants and then inputs the customer's requests regarding this hairstyle such as a request that the customer looks “youthful”, “active”, or “expansive” into a system. Meanwhile, the system takes a picture of the customer's face and analyzes the customer's face. The system selects operation data from operation data stored in storage means based on the requests of the customer and the result of the analysis of the customer's face.

As described above, according to the technique disclosed in Japanese Unexamined Patent Application Publication No. 2017-016418, it is possible to propose operation data corresponding the customer's request.

However, the operation data proposed by the technique disclosed in Japanese Unexamined Patent Application Publication No. 2017-016418 is stored in the storage means in advance. It is therefore difficult for the technique disclosed in Japanese Unexamined Patent Application Publication No. 2017-016418 to propose a procedure for making a hairstyle more precisely meeting a customer's request.

### SUMMARY

An object of the present disclosure is to provide a hairstyle making procedure proposal apparatus, a hairstyle making procedure proposal method, and a non-transitory computer readable medium capable of proposing a procedure for making a hairstyle more precisely meeting a request from a customer.

In an example aspect, a hairstyle making procedure proposal apparatus includes:

an input unit configured to receive an input of a requirement and a condition for a hairstyle;

a correspondence relationship storage unit configured to store a first correspondence relationship representing a correspondence relationship between an element characterizing the hairstyle and the hairstyle;

a hairstyle model storage unit configured to store a hairstyle model including a variable for each type of hairstyle;

a hairstyle making procedure storage unit configured to store a hairstyle making procedure including a variable for each type of hairstyle;

an optimum hairstyle search unit configured to select the type of hairstyle based on the element included in the requirement input to the input unit and the first correspondence relationship, determine a value of the variable included in the hairstyle model of the selected type of hairstyle based on the condition input to the input unit, and assign the determined value of the variable included in the hairstyle model to the variable included in the hairstyle making procedure of the selected type of hairstyle; and

an output unit configured to output the type of hairstyle selected by the optimum hairstyle search unit and output the hairstyle making procedure after the value is assigned to the variable by the optimum hairstyle search unit.

In another example aspect, a hairstyle making procedure proposal method performed by a hairstyle making procedure proposal apparatus includes:

storing a first correspondence relationship representing a correspondence relationship between an element characterizing the hairstyle and the hairstyle;

storing a hairstyle model including a variable for each type of hairstyle;

storing a hairstyle making procedure including a variable for each type of hairstyle;

receiving an input of a requirement and a condition for the hairstyle;

selecting the type of hairstyle based on the element included in the input requirement and the first correspondence relationship, determining a value of the variable included in the hairstyle model of the selected type of hairstyle based on the input condition, and assigning the determined value of the variable included in the hairstyle model to the variable included in the hairstyle making procedure of the selected type of hairstyle; and

outputting the selected type of hairstyle and output the hairstyle making procedure after the value is assigned to the variable.

In another example aspect, a non-transitory computer readable medium storing a program for causing a computer to execute:

a procedure of storing a first correspondence relationship representing a correspondence relationship between an element characterizing the hairstyle and the hairstyle;

a procedure of storing a hairstyle model including a variable for each type of hairstyle;

a procedure of storing a hairstyle making procedure including a variable for each type of hairstyle;

a procedure of receiving an input of a requirement and a condition for the hairstyle;

a procedure of selecting the type of hairstyle based on the element included in the input requirement and the first correspondence relationship, determining a value of the variable included in the hairstyle model of the selected type of hairstyle based on the input condition, and assigning the determined value of the variable included in the hairstyle model to the variable included in the hairstyle making procedure of the selected type of hairstyle; and

a procedure of outputting the selected type of hairstyle and output the hairstyle making procedure after the value is assigned to the variable.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram showing a configuration example of a hairstyle making procedure proposal apparatus according to a first example embodiment;

FIG. 2 shows an example of hairstyle characteristic correspondence relationships stored in a hairstyle characteristic correspondence relationship storage unit according to the first example embodiment;

FIG. 3 shows an example of a hairstyle model stored in a hairstyle model storage unit according to the first example embodiment;

FIG. 4 shows an example of a hairstyle making procedure stored in a hairstyle making procedure storage unit according to the first example embodiment;

FIG. 5 shows an example of an input source terminal and an output destination terminal for the hairstyle making procedure proposal apparatus according to the first example embodiment;

FIG. 6 shows an example of an input source terminal and an output destination terminal for the hairstyle making procedure proposal apparatus according to the first example embodiment;

FIG. 7 shows an example of an input source terminal for the hairstyle making procedure proposal apparatus according to the first example embodiment;

FIG. 8 is a flowchart for explaining an example of a schematic flow of an operation of the hairstyle making procedure proposal apparatus according to the first example embodiment;

FIG. 9 is a flowchart for explaining an example of a schematic flow of an operation of Step S20 shown in FIG. 8;

FIG. 10 is a flowchart for explaining an example of a schematic flow of an operation of Step S30 shown in FIG. 8;

FIG. 11 is a diagram for explaining a specific example of the operation of Step S10 shown in FIG. 8;

FIG. 12 is a diagram for explaining a specific example of the operation of Step S20 shown in FIG. 8;

FIG. 13 is a diagram for explaining a specific example of the operation of Step S30 shown in FIG. 8;

FIG. 14 is a diagram for explaining a specific example of the operation of Step S40 shown in FIG. 8;

FIG. 15 is a diagram for explaining a specific example of the operation of Step S50 shown in FIG. 8;

FIG. 16 is a block diagram showing a configuration example of a hairstyle making procedure proposal apparatus according to a second example embodiment;

FIG. 17 is a flowchart for explaining an example of a schematic flow of an operation of the hairstyle making procedure proposal apparatus according to the second example embodiment; and

FIG. 18 is a block diagram showing a hardware configuration example of a hairstyle making procedure proposal apparatus according to a third example embodiment.

### EXAMPLE EMBODIMENT

Example embodiments of the present disclosure will be described below with reference to the drawings. The following descriptions and drawings are omitted and simplified as appropriate for the purpose of clarifying the description. In the following drawings, the same elements are denoted by the same reference signs, and repeated descriptions thereof are omitted if necessary.

### First Example Embodiment

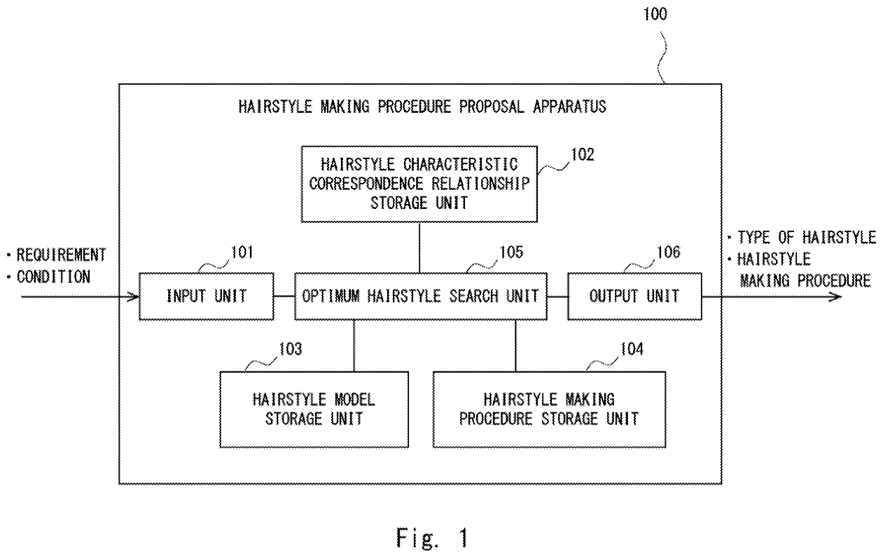

First, a configuration example of a hairstyle making procedure proposal apparatus 100 according to a first example embodiment will be described with reference to FIG. 1. As shown in FIG. 1, the hairstyle making procedure proposal apparatus 100 according to the first example embodiment includes an input unit 101, a hairstyle characteristic correspondence relationship storage unit 102, a hairstyle model storage unit 103, a hairstyle making procedure storage unit 104, an optimum hairstyle search unit 105, and an output unit 106. Note that the hairstyle characteristic correspondence relationship storage unit 102 is an example of a correspondence relationship storage unit.

The input unit 101 receives an input of requirements and conditions for hairstyles. The requirements for hairstyles include, for example, sample data of hairstyles, sensibility to describe the hairstyle, an emotion to describe the hairstyle, a hairstyle of a customer, a hair color of the customer, and so on. The conditions for hairstyles include, for example, a price and the hair color of the customer.

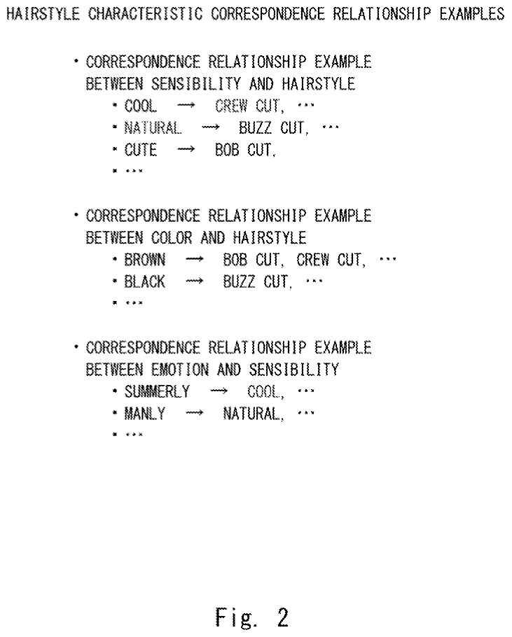

The hairstyle characteristic correspondence relationship storage unit 102 stores hairstyle characteristic correspondence relationships. The hairstyle characteristic correspondence relationship includes a first correspondence relationship representing a correspondence relationship between an element characterizing a hairstyle and a type of hairstyle. In the first example embodiment, the hairstyle characteristic correspondence relationship also includes a second correspondence relationship representing a correspondence relationship between the elements characterizing the hairstyle. However, the hairstyle characteristic correspondence relationship may or may not include the second correspondence relationship. Here, an example of the hairstyle characteristic correspondence relationship including the first correspondence relationship and the second correspondence relationship stored in the hairstyle characteristic correspondence relationship storage unit 102 will be described with reference to FIG. 2. In the example of FIG. 2, the hairstyle characteristic correspondence relationship storage unit 102 stores, as the first correspondence relationship, for example, a correspondence relationship between the sensibility and type of hairstyle, a correspondence relationship between the color and type of hairstyle, and so on. In the example of FIG. 2, the hairstyle characteristic correspondence relationship storage unit 102 stores, as the second correspondence relationship, for example, a correspondence relationship between the emotion and sensibility. That is, the examples shown in FIG. 2 is a diagram for conceptually and illustratively explaining data structures stored in the hairstyle characteristic correspondence relationship storage unit 102. In the respective examples shown in FIG. 2, the items described on the right and left sides of the arrow represent data constituting the data structure and are related to each other (i.e., the aforementioned correspondence relationship).

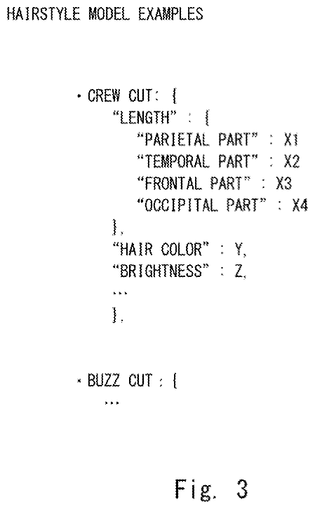

The hairstyle model storage unit 103 stores, for each type of hairstyle, a hairstyle model of the hairstyle including components of the hairstyle model and undetermined variables. Referring now to FIG. 3, an example of the hairstyle model stored in the hairstyle model storage unit 103 will be described. In the example of FIG. 3, hairstyle models such as crew cut and buzz cut are stored in the hairstyle model storage unit 103. For example, in the hairstyle model of crew cut, a length of parietal part X1, a length of temporal part X2, a length of frontal part X3, a length of occipital part X4, a hair color Y, and brightness Z are undetermined variables. That is, the example shown in FIG. 3 is a diagram for conceptually and illustratively explaining the data structure of the hairstyle model stored in the hairstyle model storage unit 103. The example of the hairstyle model “crew cut” shown in FIG. 3 shows that the aforementioned variables are associated with each other as the data constituting the data structure.

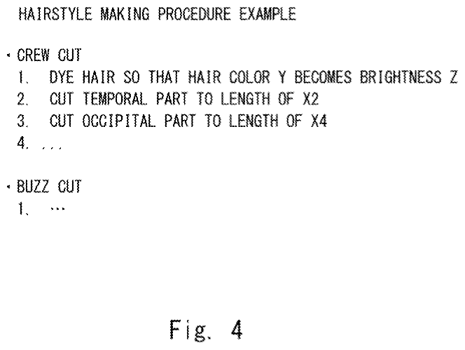

The hairstyle making procedure storage unit 104 stores, for each type of hairstyle, a hairstyle making procedure of the hairstyle including a constitution procedure of the hairstyle making procedure and undetermined variables. Here, an example of the hairstyle making procedure stored in the hairstyle making procedure storage unit 104 will be described with reference to FIG. 4. In the example of FIG. 4, the hairstyle making procedure storage unit 104 stores the hairstyle making procedures of, for example, crew cut and buzz cut. For example, in the hairstyle making procedure for crew cut, the length of parietal part X1 (not shown), the length of temporal part X2 (not shown), the length of frontal part X3 (not shown), the length of occipital part X4 (not shown), the hair color Y, and the brightness Z are undetermined variables. That is, the example shown in FIG. 4 is a diagram for conceptually and illustratively explaining the data structure of the hairstyle making procedure stored in the hairstyle making procedure storage unit 104. An example of the procedure for making the hairstyle “crew cut” shown in FIG. 4 shows that, as the data constituting the data structure, the procedures 1 to 3 shown in FIG. 4 represent the order and are related to each other in a state including the variables described with reference to FIG. 3.

As shown in FIGS. 3 and 4, the hairstyle models and hairstyle making procedures for the hairstyles of the same type (in the example of FIGS. 3 and 4, crew cut) include variables identical to each other as the undetermined variables.

The optimum hairstyle search unit 105 first selects the type of hairstyle based on elements included in the requirements input to the input unit 101 and the first correspondence relationship stored in the hairstyle characteristic correspondence relationship storage unit 102. If the second correspondence relationship is stored in the hairstyle characteristic correspondence relationship storage unit 102, the optimum hairstyle search unit 105 may select the type of hairstyle based on the elements included in the requirements input to the input unit 101 and the first and second correspondence relationships. Next, the optimum hairstyle search unit 105 reads the hairstyle model of the hairstyle of the selected type from the hairstyle model storage unit 103, and determines a value of each undetermined variable included in the read hairstyle model based on the condition input to the input unit 101. Next, the optimum hairstyle search unit 105 reads the hairstyle making procedure of the hairstyle of the selected type from the hairstyle making procedure storage unit 104, and assigns the value of each variable included in the hairstyle model determined above to each undetermined variable included in the read hairstyle making procedure.

The output unit 106 outputs the type of hairstyle selected by the optimum hairstyle search unit 105, and also outputs the hairstyle making procedure of the hairstyle, in which the values are assigned to the variables by the optimum hairstyle search unit 105.

The optimum hairstyle search unit 105 is not limited to selecting only one type of hairstyle, and instead may select a predetermined number of types of hairstyle as described later. In this case, the optimum hairstyle search unit 105 may assign the values to the variables included in the hairstyle making procedure for each selected type of hairstyle. The output unit 106 may output the predetermined number of types of hairstyles selected by the optimum hairstyle search unit 105, and may also output the hairstyle making procedure after the optimum hairstyle search unit 105 has assigned the values to the variables in the hairstyle making procedure of each selected type of hairstyle.

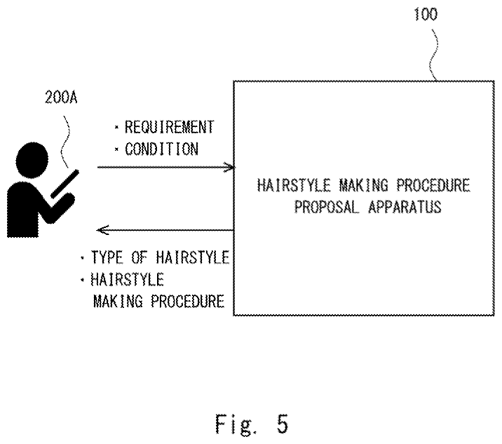

Next, examples of an input source terminal and an output destination terminal for the hairstyle making procedure proposal apparatus 100 according to the first example embodiment will be described with reference to FIGS. 5 to 7.

In the example of FIG. 5, one terminal 200A is an input source terminal and also an output destination terminal.

For example, the terminal 200A is used by a customer who visits a hair salon. The use scene in this case is, for example, as follows. The customer inputs his/her requirements and conditions for the hairstyle and obtains the output of the type of hairstyle and the hairstyle making procedure. The customer presents the output result to the hairstylist or another staff, and the hairstylist works on the hair of the customer based on the output result.

Alternatively, the terminal 200A may be used by the hairstylist or another staff working in the hair salon. The use scene in this case is, for example, as follows. The hairstylist or another staff listens to the customer's requirements and conditions for the hairstyle, inputs the customer's requirements and conditions, and obtains the output of the type of hairstyle and the hairstyle making procedure. The hairstylist works on the hair of the customer based on the output result. There may also be requests from the hair salons regarding the price or the like. Thus, the hairstylist or another staff may input additional hair salon requirements and conditions for hairstyles.

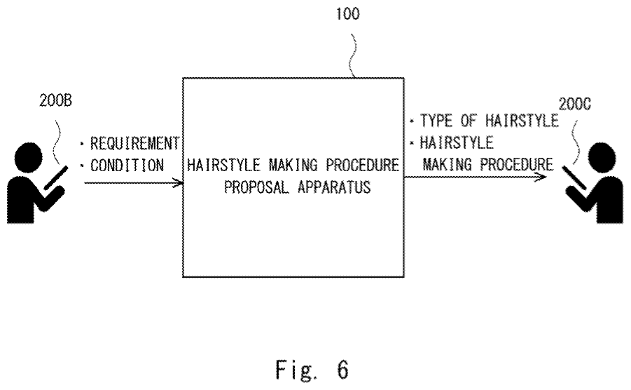

In the example of FIG. 6, one terminal 200B is an input source terminal, and another terminal 200C different from the terminal 200B is an output destination terminal.

For example, the terminal 200B is used by a customer who comes to a hair salon, and the terminal 200C is used by a hairstylist or another staff working at the shop. The use scene in this case is, for example, as follows. The customer inputs the customer's requirements and conditions for the hairstyle. The hairstylist or another staff obtains the output of the type of hairstyle and the hairstyle making procedure, and the hairstylist works on the hair of the customer based on the output result.

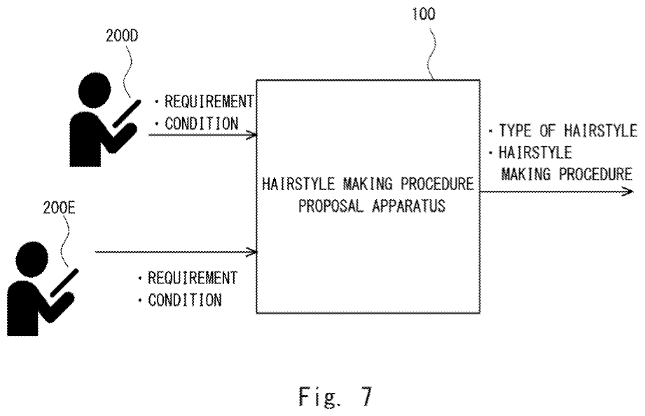

In the example of FIG. 7, a plurality of (in FIG. 7, two) terminals 200D and 200E are input source terminals.

For example, the terminal 200D is used by a customer who comes to a hair salon, and the terminal 200E is used by a hairstylist or another staff working in the hair salon. The use scene in this case is, for example, as follows. The customer inputs the customer's requirements and conditions for the hairstyle. The hairstylist or another staff also inputs the hair salon's requirements and conditions for the hairstyle.

In the example of FIG. 7, although the output destination terminal is not shown, the output destination terminal may be any terminal. For example, the output destination terminal may be one or both of the terminals 200D and 200E, or may be any one or more terminals other than the terminals 200D and 200E.

Note that the terminals 200A to 200E shown in FIGS. 5 to 7 may have at least an input function, a communication function, and a display function. The terminals 200A to 200E shown in FIGS. 5 to 7 are portable terminals, and instead may be stationary fixed terminals.

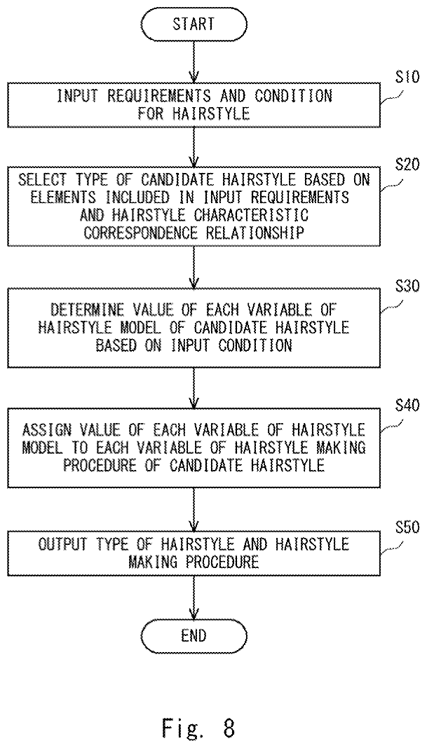

Next, an example of a flow of a schematic operation of the hairstyle making procedure proposal apparatus 100 according to the first example embodiment will be described with reference to FIG. 8. When the flow of FIG. 8 is started, it is assumed that the hairstyle characteristic correspondence relationship storage unit 102 stores the hairstyle characteristic correspondence relationships including the first correspondence relationship and the second correspondence relationship, the hairstyle model storage unit 103 stores the hairstyle models, and the hairstyle making procedure storage unit 104 stores the hairstyle making procedures.

As shown in FIG. 8, first, the requirements and conditions for a hairstyle are input to the input unit 101 (Step S10).

Next, the optimum hairstyle search unit 105 selects a type of candidate hairstyle based on the elements included in the requirements input to the input unit 101 in Step S10 and the first and second correspondence relationships stored in the hairstyle characteristic correspondence relationship storage unit 102 (Step S20).

Next, the optimum hairstyle search unit 105 reads the hairstyle model of the candidate hairstyle selected in Step S20 from the hairstyle model storage unit 103, and determines the value of each undetermined variable included in the read hairstyle model based on the condition input to the input unit 101 (Step S30).

Next, the optimum hairstyle search unit 105 reads the hairstyle making procedure of the candidate hairstyle selected in Step S20 from the hairstyle making procedure storage unit 104, and assigns the values of the variables determined in Step S30 and included in the hairstyle model to the undetermined variables included in the read hairstyle making procedure (Step S40).

After that, the output unit 106 outputs the type of hairstyle selected by the optimum hairstyle search unit 105 in Step S20, and also outputs the hairstyle making procedure of the hairstyle, in which the optimum hairstyle search unit 105 assigns values to the respective variables in Step S40 (Step S50).

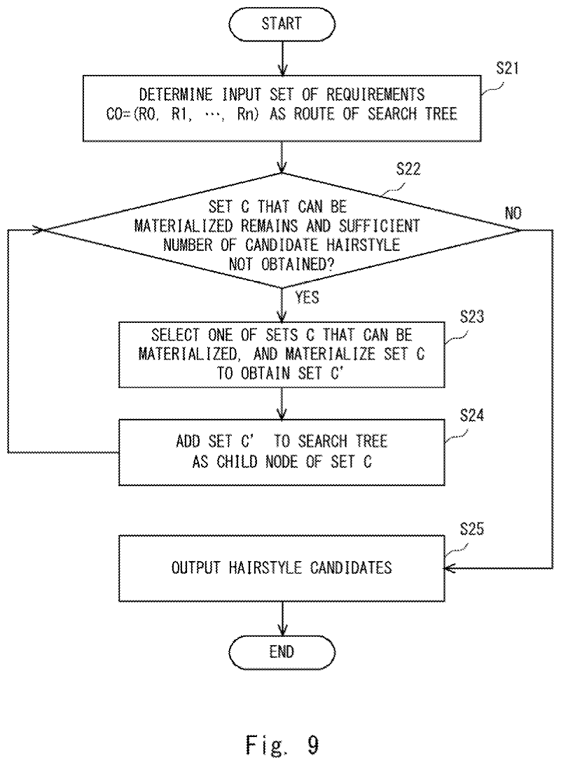

Next, an example of the flow of the schematic operation in Step S20 shown in FIG. 8 will be described with reference to FIG. 9. In FIG. 9, a set of requirements for hairstyles is indicated by a symbol C, and in particular, a set of requirements for hairstyles input to the input unit 101 is indicated by a symbol C0.

As shown in FIG. 9, first, the optimum hairstyle search unit 105 determines the set of requirements C0=(R0, R1, . . . , Rn) input to the input unit 101 as a route of a search tree (Step S21). The search tree has a set of requirements as nodes.

Next, the optimum hairstyle search unit 105 determines whether or not the condition “There still remains a set C that can be materialized and a sufficient number of candidate hairstyles has not been obtained” is satisfied (Step S22). Here, the “sufficient number” is predetermined.

If the conditions described above are satisfied in Step S22 (YES in Step S22), the optimum hairstyle search unit 105 selects one of the sets C that can be materialized, and materializes the set C based on the first correspondence relationship and the second correspondence relationship stored in the hairstyle characteristic correspondence relationship storage unit 102 to obtain a set C′ (Step S23). In Step S23, the optimum hairstyle search unit 105 creates the set C′ by materializing the set C based on the first correspondence relationship and the second correspondence relationship.

Next, the optimum hairstyle search unit 105 adds the set C′ to the search tree as a child node of the set C selected in Step S23 (Step S24). The set C added to the search tree is one of the candidate hairstyles. After Step S24, the optimum hairstyle search unit 105 returns to Step S22 and repeats the processing from Step S22.

If the condition “There still remains a set C that can be materialized and a sufficient number of hairstyles has not been obtained” is not satisfied in Step S22 (NO in Step S22), the optimum hairstyle search unit 105 outputs the types of hairstyle candidates obtained so far (Step S25), and the processing ends.

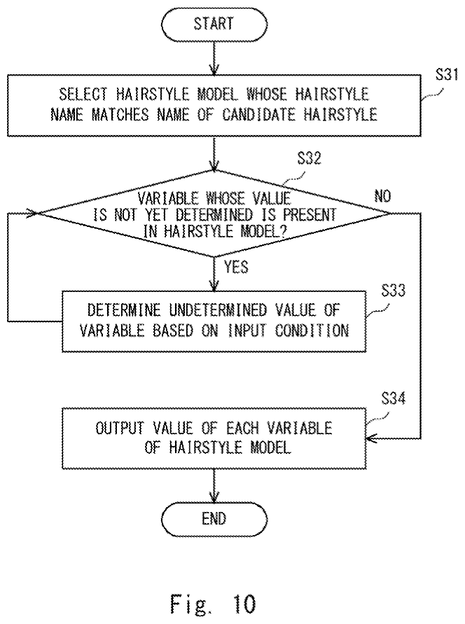

Next, an example of the flow of the schematic operation in Step S30 shown in FIG. 8 will be described with reference to FIG. 10. The flow shown in FIG. 10 is performed for each candidate hairstyle. For example, if there are two candidate hairstyles, crew cut and buzz cut, the flow shown in FIG. 10 is performed for each crew cut and buzz cut.

As shown in FIG. 10, first, the optimum hairstyle search unit 105 selects a hairstyle model whose hairstyle name matches a name of the candidate hairstyle from among the hairstyle models stored in the hairstyle model storage unit 103, and reads the selected hairstyle model from the hairstyle model storage unit 103 (Step S31).

Next, the optimum hairstyle search unit 105 determines whether a variable whose value is not yet determined is present in the variables included in the hairstyle model read in Step S31 (Step S32).

In Step S32, if there is a variable whose value is not yet determined (YES in Step S32), the optimum hairstyle search unit 105 determines the undetermined value of each variable included in the hairstyle model based on the condition input to the input unit 101 (Step S33). After Step S33, the optimum hairstyle search unit 105 returns to Step S32 and repeats the processing from Step S32.

If there is no variable whose value is not yet determined in Step S32 (NO in Step S32), the optimum hairstyle search unit 105 outputs the determined value of each variable of the hairstyle model (Step S34), and the processing ends.

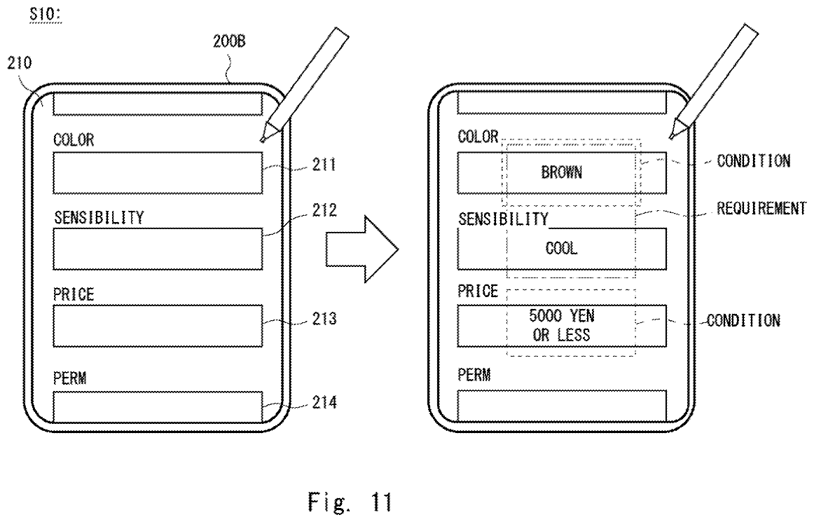

Next, specific examples of operations of Steps S10 to S50 shown in FIG. 8 will be described with reference to FIGS. 11 to 15. In FIGS. 11 to 15, it is assumed that an input source terminal is the terminal 200B and an output destination terminal is the terminal 200C (see FIG. 6). The terminal 200B is used by the customer, and the terminal 200C is used by the hairstylist.

### Step S10:

First, a specific example of the operation of Step S10 shown in FIG. 8 will be described with reference to FIG. 11.

As shown in FIG. 11, the input unit 101 displays an input screen 210 for inputting the requirements and condition for a hairstyle on a display of the terminal 200B. The input screen 210 includes areas 211 to 214. The area 211 is for inputting the hair color of the hairstyle, the area 212 is for inputting the sensibility to describe the hairstyle, the area 213 is for inputting the price of the hairstyle, and the area 214 is for inputting the presence or absence of the perm of the hairstyle. The input screen 210 also includes other areas, which can be displayed by scrolling up and down.

The customer inputs text data in an optional area among the areas 211 to 214 included in the input screen 210. In the example of FIG. 11, input by a touch pen or the like is assumed. Alternatively, the text data may be input by any method such as keyboard input.

In the example of FIG. 11, the customer inputs the color “brown” in the area 211, the sensibility “cool” in the area 212, and the price “5000 yen or less” in the area 213. Among them, the color “brown” and the sensibility “cool” are the elements which constitute the requirements for the hairstyle, and the color “brown” and the price “5000 yen or less” are the conditions for the hairstyle. For each area, it is predetermined whether the text data input to the area is a requirement, a condition, or both a requirement and a condition.

### Step S20:

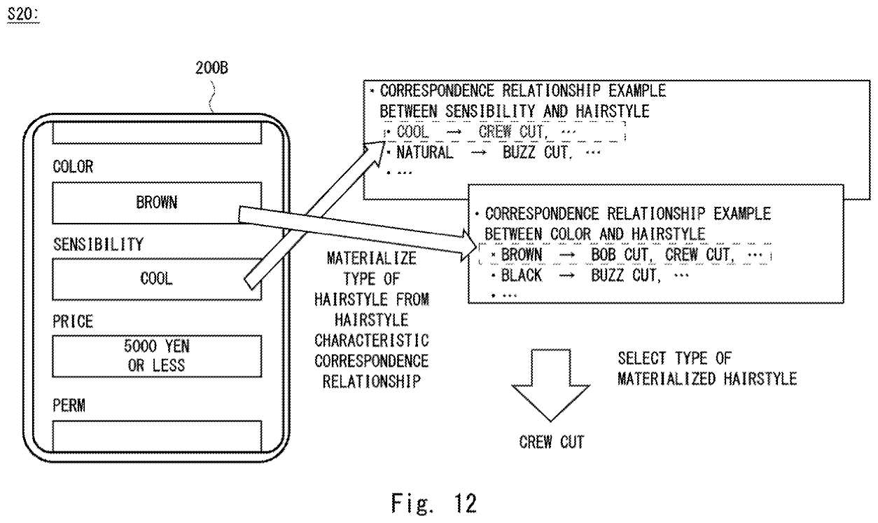

Next, a specific example of the operation of Step S20 shown in FIG. 8 will be described with reference to FIG. 12.

As shown in FIG. 12, the optimum hairstyle search unit 105 materializes the types of candidate hairstyles based on the color “brown” and the sensibility “cool” input to the input unit 101 as the requirements in Step S10 and the first correspondence relationship and the second correspondence relationship stored in the hairstyle characteristic correspondence relationship storage unit 102.

In the example shown in FIG. 12, the hairstyle characteristic correspondence relationship storage unit 102 stores, as the first correspondence relationship, the correspondence relationship between the sensibility and the type of hairstyle, and the correspondence relationship between the color and the type of hairstyle. According to this, the type of hairstyle corresponding to the sensibility “cool” is “crew cut”, and the types of hairstyle corresponding to the color “brown” are “bob cut” and “crew cut”.

For this reason, the optimum hairstyle search unit 105 materializes the color “brown” and the sensibility “cool” input to the input unit 101 as the requirements into “crew cut”, and selects the materialized “crew cut” as the type of candidate hairstyle.

### Step S30:

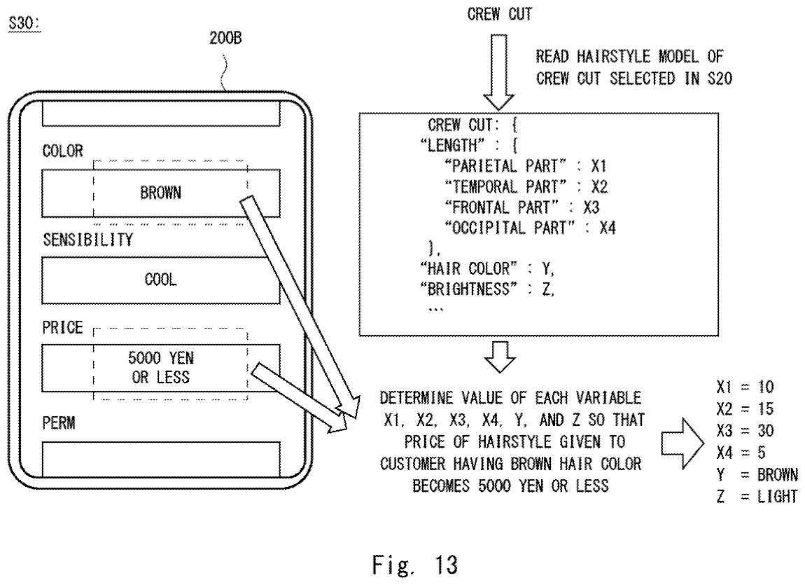

Next, a specific example of the operation of Step S30 shown in FIG. 8 will be described referring to FIG. 13.

As shown in FIG. 13, first, the optimum hairstyle search unit 105 reads the hairstyle model of “crew cut” selected in Step S20 from the hairstyle model storage unit 103.

In the example of FIG. 13, in the hairstyle model of “crew cut”, the length of parietal part X1, the length of temporal part X2, the length of frontal part X3, the length of occipital part X4, the hair color Y, and the brightness Z are variables whose values are not yet determined.

Thus, the optimum hairstyle search unit 105 determines the values of the variables X1, X2, X3, X4, Y, and Z so as to satisfy the price “5000 yen or less” input to the input unit 101 as a condition, that is, so that the crew cut given to the customer having brown hair color becomes 5000 yen or less. Specifically, in the example of FIG. 13, the length of parietal part X1 is determined to be “10 mm (millimeters, which is applied in the following descriptions)”, the length of temporal part X2 is determined to be “15 mm”, the length of frontal part X3 is determined to be “30 mm”, the length of occipital part X4 is determined to be “5 mm”, the hair color Y is determined to be “brown”, and the brightness Z is determined to be “light”.

### Step S40:

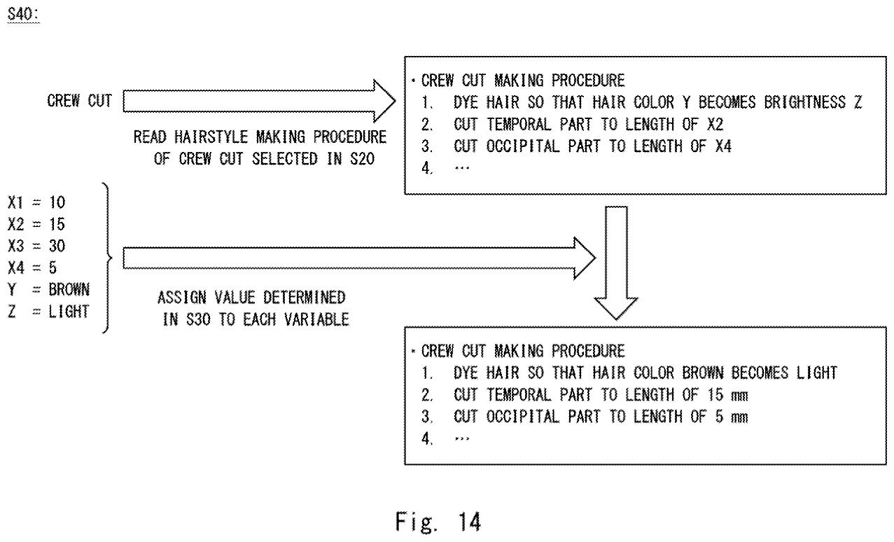

Next, a specific example of the operation of Step S40 shown in FIG. 8 will be described with reference to FIG. 14.

As shown in FIG. 14, first, the optimum hairstyle search unit 105 reads the hairstyle making procedure of the “crew cut” selected in Step S20 from the hairstyle making procedure storage unit 104.

In the example of FIG. 14, variables X1, X2, X3, X4, Y, and Z are variables whose values are not yet determined in the hairstyle making procedure of “crew cut” as in the hairstyle model of “crew cut”. However, the values of the variables X1, X2, X3, X4, Y, and Z are determined in Step S30.

Thus, the optimum hairstyle search unit 105 assigns the values of the variables X1, X2, X3, X4, Y, and Z determined in Step S30 for the hairstyle model of the “crew cut” to the variables X1, X2, X3, X4, Y, and Z included in the hairstyle making procedure of the “gin tonic”. Specifically, in the example of FIG. 14, “10 mm” is assigned to the variable X1 (not shown), “15 mm” is assigned to the variable X2 (not shown), “30 mm” is assigned to the variable X3 (not shown), “5 mm” is assigned to the variable X4 (not shown), “brown” is assigned to the variable Y (not shown), and “light” is assigned to the variable Z (not shown).

### Step S50:

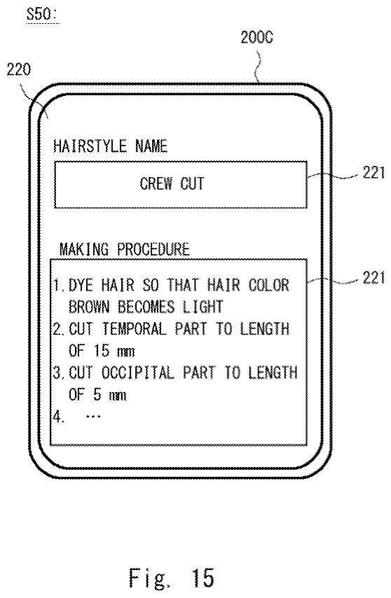

Next, a specific example of the operation of Step S50 shown in FIG. 8 will be described with reference to FIG. 15.

As shown in FIG. 15, the output unit 106 causes the display of the terminal 200C to display an output screen 220 for displaying the type of hairstyle and the hairstyle making procedure to be proposed to the hairstylist. The output screen 220 includes areas 221 and 222. The area 221 is for displaying the type of hairstyle to be proposed to the hairstylist, and the area 222 is for displaying the hairstyle making procedure of the hairstyle to be proposed to the hairstylist. The output screen 220 may include other areas, and the other areas may be displayed by scrolling up and down.

In the example of FIG. 15, the area 221 displays the name of the “crew cut” to be proposed to the hairstylist, and the area 222 displays the procedure for making “crew cut” proposed to the hairstylist.

As described above, according to the first example embodiment, the hairstyle characteristic correspondence relationship storage unit 102 stores the first correspondence relationship representing the correspondence relationship between the elements characterizing a hairstyle and the type of hairstyle. The hairstyle model storage unit 103 stores the hairstyle model including the variables for each type of hairstyle, and the hairstyle making procedure storage unit 104 stores the hairstyle making procedure including the variables for each type of hairstyle. The optimum hairstyle search unit 105 selects the type of hairstyle based on the elements included in the requirements input to the input unit 101 and the first correspondence relationship. The optimum hairstyle search unit 105 determines the value of the variable included in the hairstyle model of the selected hairstyle based on the condition input to the input unit 101. The optimum hairstyle search unit 105 assigns the determined values of the variables included in the hairstyle model to the variables included in the selected hairstyle making procedure. The output unit 106 outputs the selected type of hairstyle and also the hairstyle making procedure of the selected hairstyle in which the determined values are assigned to the variables.

As described above, according to the first example embodiment, instead of outputting the hairstyle making procedure stored in the hairstyle making procedure storage unit 104 as it is, the variables included in the hairstyle making procedure are optimized based on the condition input to the input unit 101, and the hairstyle making procedure in which the variables are optimized is output. In this way, the hairstyle making procedure more precisely meeting the customer's request can be proposed.

Further, according to the first example embodiment, the hairstyle characteristic correspondence relationship storage unit 102 may further store the second correspondence relationship representing the correspondence relationship between the elements characterizing the hairstyle. The optimum hairstyle search unit 105 may select the type of hairstyle based on the elements included in the requirements input to the input unit 101 and the first and second correspondence relationships. This makes it easier to materialize the input requirements, thereby facilitating selection of the type of hairstyle.

### Second Example Embodiment

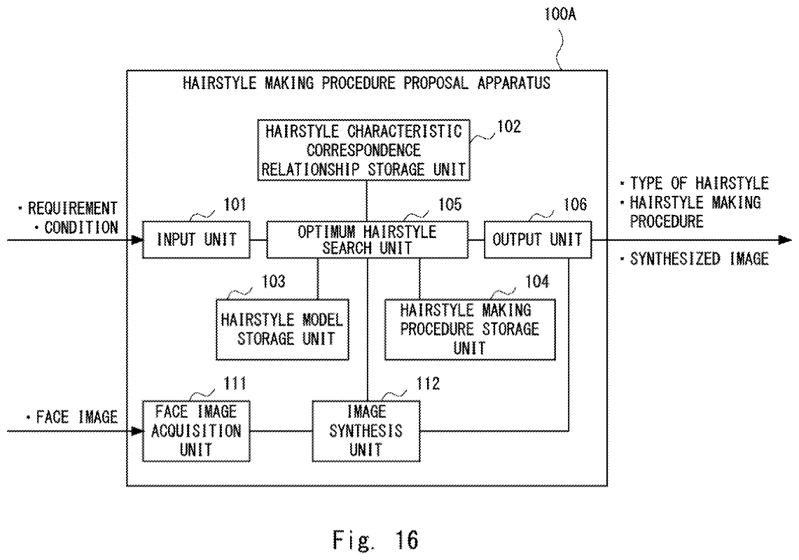

A configuration example of a hairstyle making procedure proposal apparatus 100A according to a second example embodiment will be described with reference to FIG. 16. As shown in FIG. 16, the hairstyle making procedure proposal apparatus 100A according to the second example embodiment differs from the hairstyle making procedure proposal apparatus 100 according to the first embodiment in that a face image acquisition unit 111 and an image synthesis unit 112 are added to the hairstyle making procedure proposal apparatus 100A according to the second example embodiment.

The face image acquisition unit 111 acquires a face image. Hereinafter, it is assumed that the face image acquisition unit 111 acquires a face image of a customer. The face image acquisition unit 111 may acquire the face image of the customer by capturing the face of the customer, or may acquire, from a terminal (not shown), the face image of the customer already captured. The face image of the customer may be a still image or a moving image.

The image synthesis unit 112 synthesizes a hairstyle corresponding to a hairstyle making procedure in which values are assigned to variables by the optimum hairstyle search unit 105 with the face image of the customer acquired by the face image acquisition unit 111 to create a synthesized image. At this time, if the face image of the customer is a still image, the synthesized image is a still image, whereas if the face image of the customer is a moving image, the synthesized image is a moving image. The synthesized image as the moving image may be, for example, a VR (Virtual Reality) moving image.

The output unit 106 outputs the synthesized image created by the image synthesis unit 112 in addition to or instead of the type of hairstyle and the hairstyle making procedure. The output destination of the synthesized image is generally a terminal used by the customer, a hairstylist or the like. However, when the synthesized image is a VR moving image, the output destination of the synthesized image may be a VR goggle.

In the following description, it is assumed that either a first output mode or a second output mode is set to the output unit 106. It is also assumed that when the first output mode is set, the output unit 106 outputs the type of hairstyle and the hairstyle making procedure, while when the second output mode is set, the output unit 106 outputs the synthesized image.

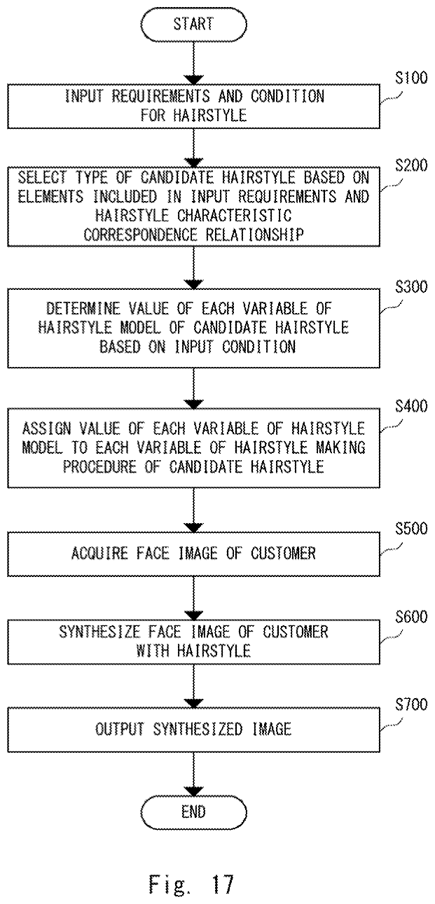

Next, an example of the flow of the schematic operation of the hairstyle making procedure proposal apparatus 100A according to the second example embodiment will be described. The operation when the first output mode is set to the output unit 106 is the same as the flow of FIG. 8 described above. Therefore, the operation when the second output mode is set to the output unit 106 will be described below with reference to FIG. 17. Note that the state of the hairstyle characteristic correspondence relationship storage unit 102, the hairstyle model storage unit 103, and the hairstyle making procedure storage unit 104 at the time when the flow of FIG. 17 is started is the same as that at the time when the flow of FIG. 8 is started.

As shown in FIG. 17, first, Steps S100 to S400 similar to Steps S10 to S40 in FIG. 8, respectively, are performed.

Next, the face image acquisition unit 111 acquires the face image of the customer (Step S500).

Next, the image synthesis unit 112 synthesizes the hairstyle corresponding to the hairstyle making procedure in which the values are assigned to the variables by the optimum hairstyle search unit 105 in Step S400 with the face image of the customer acquired by the face image acquisition unit 111 in Step S500 to create the synthesized image (Step S600).

After that, the output unit 106 outputs the synthesized image created by the image synthesis unit 112 in Step S600 (Step S700).

Note that Step S500 may be performed before Step S600 and is not limited to being performed after Steps S100 to S400. For example, Step S500 may be performed before Step S100, or may be performed in parallel with Steps S100 to S400 during Steps S100 to S400.

As described above, according to the second example embodiment, the face image acquisition unit 111 acquires a face image of a customer. An image synthesis unit 112 synthesizes a hairstyle corresponding to a hairstyle making procedure with the face image of the customer to create a synthesized image. The output unit 106 outputs the synthesized image. This allows customers to see what they look like in the proposed hairstyle before the operation. Thus, if the proposed hairstyle is not suitable for the customer's preference, the customer can find the hairstyle suitable for the customer's preference by changing requirements and conditions. Other effects are the same as those of the first example embodiment.

### Third Example Embodiment

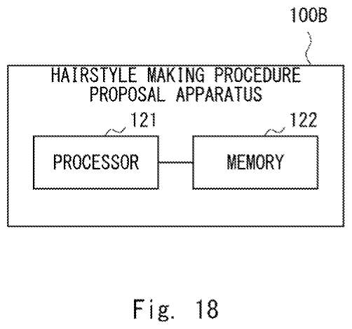

A hardware configuration example of a hairstyle making procedure proposal apparatus 100B according to a third example embodiment will be described with reference to FIG. 18. As shown in FIG. 18, the hairstyle making procedure proposal apparatus 100B according to the third example embodiment includes a processor 121 and a memory 122.

The processor 121 may be, for example, a microprocessor, an MPU (Micro Processing Unit), or a CPU (Central Processing Unit). The processor 121 may include a plurality of processors.

The memory 122 is composed of a combination of a volatile memory and a non-volatile memory. The memory 122 may include storage separated from the processor 121. In this case, the processor 121 may access the memory 122 via an I (Input)/O (Output) interface (not shown).

Each of the hairstyle making procedure proposal apparatuses 100 and 100A according to the first and second example embodiments, respectively, may have a hardware configuration shown in FIG. 18. The input unit 101, the optimum hairstyle search unit 105, and the output unit 106 in the above-described hairstyle making procedure proposal apparatuses 100 and 100A, and the face image acquisition unit 111 and the image synthesis unit 112 in the above-described hairstyle making procedure proposal apparatus 100A may be realized by the processor 121 reading and executing programs stored in the memory 122. Further, the hairstyle characteristic correspondence relationship storage unit 102, the hairstyle model storage unit 103, and the hairstyle making procedure storage unit 104 in the hairstyle making procedure proposal apparatuses 100 and 100A may be realized by the memory 122.

The above-mentioned program can be stored and provided to a computer (including a computer 50) using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (Compact Disc-ROM), CD-R (CD-Recordable), CD-R/W (CD-ReWritable), and semiconductor memories (such as mask ROM, PROM (Programmable ROM), EPROM (Erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Although the present disclosure has been described above with reference to the example embodiments, the present disclosure is not limited to the example embodiments described above. The configuration and details of the present disclosure may be modified in various ways that would be understood by those skilled in the art within the scope of the present disclosure.

For example, in the example embodiments described above, a scene used by a customer, a hairstylist, or another staff in a hair salon has been described as an example of a use scene of the present disclosure. However, the present disclosure is not limited to this. The disclosure may be However used, for example, by a customer before visiting a hair salon.

What is claimed is:

1. A hairstyle making procedure proposal apparatus comprising:
an input unit configured to receive an input of a requirement and a condition for a hairstyle;
a correspondence relationship storage unit configured to store a first correspondence relationship representing a correspondence relationship between an element characterizing the hairstyle and the hairstyle;
a hairstyle model storage unit configured to store a hairstyle model including a variable for each type of hairstyle;
a hairstyle making procedure storage unit configured to store a hairstyle making procedure including a variable for each type of hairstyle;
an optimum hairstyle search unit configured to select the type of hairstyle based on the element included in the requirement input to the input unit and the first correspondence relationship, determine a value of the variable included in the hairstyle model of the selected type of hairstyle based on the condition input to the input unit, and assign the determined value of the variable included in the hairstyle model to the variable included in the hairstyle making procedure of the selected type of hairstyle; and
an output unit configured to output the type of hairstyle selected by the optimum hairstyle search unit and output the hairstyle making procedure after the value is assigned to the variable by the optimum hairstyle search unit.

2. The hairstyle making procedure proposal apparatus according to claim 1, wherein
the correspondence relationship storage unit is configured to further store a second correspondence relationship representing a correspondence relationship between the elements characterizing the hairstyle, and
the optimum hairstyle search unit is configured to select the type of hairstyle based on the element included in the requirement input to the input unit, the first correspondence relationship, and the second correspondence relationship.

3. The hairstyle making procedure proposal apparatus according to claim 1, further comprising:
a face image acquisition unit configured to acquire a face image; and
an image synthesis unit configured to synthesize the hairstyle corresponding to the hairstyle making procedure after the value is assigned to the variable by the optimum hairstyle search unit with the face image acquired by the face image acquisition unit to create a synthesized image, wherein
the output unit is configured to output the synthesized image created by the image synthesis unit in addition to the type of hairstyle and the hairstyle making procedure, or output the synthesized image created by the image synthesis unit in place of the type of hairstyle and the hairstyle making procedure.

4. The hairstyle making procedure proposal apparatus according to claim 1, wherein
the optimum hairstyle search unit is configured to select a predetermined number of types of hairstyle and assign the value to the variable included in the hairstyle making procedure for each selected type of hairstyle, and
the output unit is configured to output the predetermined number of types of hairstyle selected by the optimum hairstyle search unit, and output the hairstyle making procedure of each selected type of hairstyle after the value is assigned to the variable by the optimum hairstyle search unit.

5. The hairstyle making procedure proposal apparatus according to claim 1, wherein
the input unit is configured to receive the input of the requirement and condition for hairstyle from a plurality of input sources.

6. A hairstyle making procedure proposal method performed by a hairstyle making procedure proposal apparatus, the hairstyle making procedure proposal method comprising:
storing a first correspondence relationship representing a correspondence relationship between an element characterizing the hairstyle and the hairstyle;
storing a hairstyle model including a variable for each type of hairstyle;
storing a hairstyle making procedure including a variable for each type of hairstyle;
receiving an input of a requirement and a condition for the hairstyle;
selecting the type of hairstyle based on the element included in the input requirement and the first correspondence relationship, determining a value of the variable included in the hairstyle model of the selected type of hairstyle based on the input condition, and assigning the determined value of the variable included in the hairstyle model to the variable included in the hairstyle making procedure of the selected type of hairstyle; and
outputting the selected type of hairstyle and output the hairstyle making procedure after the value is assigned to the variable.

7. A non-transitory computer readable medium storing a program for causing a computer to execute:
a procedure of storing a first correspondence relationship representing a correspondence relationship between an element characterizing the hairstyle and the hairstyle;
a procedure of storing a hairstyle model including a variable for each type of hairstyle;
a procedure of storing a hairstyle making procedure including a variable for each type of hairstyle;
a procedure of receiving an input of a requirement and a condition for the hairstyle;
a procedure of selecting the type of hairstyle based on the element included in the input requirement and the first correspondence relationship, determining a value of the variable included in the hairstyle model of the selected type of hairstyle based on the input condition, and assigning the determined value of the variable included in the hairstyle model to the variable included in the hairstyle making procedure of the selected type of hairstyle; and
a procedure of outputting the selected type of hairstyle and output the hairstyle making procedure after the value is assigned to the variable.
